(19) United States
(12) Patent Application Publication
(10) Pub. No.: US 2010/0242805 A1
(43) Pub. Date: Sep. 30, 2010

(54) METHOD FOR THE PRODUCTION OF PORTLAND SLAG CEMENT AND BLAST FURNACE CEMENT

(75) Inventors: Paul Clemens, Schoeneiche (DE); Dietmar Espig, Freiberg (DE)

Correspondence Address: VIDAS, ARRETT & STEINKRAUS, P.A., SUITE 400, 6640 SHADY OAK ROAD, EDEN PRAIRIE, MN, 55344, US

(73) Assignee: HOLCIM TECHNOLOGY LTD, Jona (CH)

(21) Appl. No.: 12/680,116

(22) PCT Filed: Sep. 24, 2008
(86) PCT No.: PCT/EP08/08066

§ 371 Date: May 25, 2010

(30) Foreign Application Priority Data
Sep. 29, 2007 (DE) 10 2007 046 834.4

(51) Int. Cl. C04B 7/14

(52) U.S. Cl. 106/714

(57) ABSTRACT

A method for the production of Portland slag cement and blast furnace cement by two-step grinding, comprising the following steps:
a) Portland cement clinker is charged into a first mill for preliminary grinding, the cement mill (24),
b) the delivery material of the cement mill is supplied directly and/or via an intermediate reservoir into the inlet of a dynamic classifier,
c) slag meal or slag grit is additionally supplied into the inlet of the dynamic classifier,
d) oversized material discharged from the dynamic classifier is supplied for pulverising into the inlet of a second mill,
e) the delivery material of the second mill is fed into the inlet of the dynamic classifier, and
f) sulphate carrier is supplied either to the first mill, to the inlet of the dynamic classifier or to the inlet of the second mill, and
g) the fine material of the dynamic classifier is supplied to a reservoir.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

As is well known, Portland cement is ground from clinker. Together with a sulphate carrier, like for instance gypsum, the clinker is fed into a cement mill, a material bed roller mill (MBRM) for instance. Different classes of cement are distinguished with respect to consistency and fineness, in Portland cements for instance the classes CEM I 32.5 R, CEM I 42.5 R, and CEM I 52.5 R. The latter is that one with the highest solidity among the mentioned Portland cements. In order to obtain the required fineness for instance in a CEM I 52.5 R, it is also known two grind in two steps. Two-step grinding methods are also used to obtain higher mass throughputs, combined with significant energy savings. For instance, a material bed roller mill works in a circuit with a dynamic classifier in a first grinding step. The delivery of the dynamic classifier is fed into the inlet of for instance a ball mill as the second grinding step, which works in a circuit combined with a second dynamic classifier. The completed material separated by the classifier is delivered into corresponding reservoirs. Thus, insufficiently ground grinding stock is fed to the inlet of the second grinding step.

The choice of grinding balls having different sizes results from the variable resistance against grinding—for instance of clinker about 12-16 kWh/t and slag sand about 18-22 kWh/t—on the one hand, and from the upper grain size of the grinding stock on the other hand. Clinker is much coarser-grained than slag sand for instance, which requires very big grinding balls with a diameter of 90 to 100 mm at the mill inlet of a first grinding step. If grinding is done in two steps, a second grinding step is capable to work with balls having a diameter of 30 to 20 mm at the mill inlet, and a diameter of 12 mm at the delivery. It is to be understood that the ball diameter should decrease in the direction of the mill's delivery.

In the one-step grinding of Portland cements, it is usual to grind the supplied grinding stock in one single operation from out the initial grain up to the final fineness. In two-step grinding, it is also usual to supply the intermediate product from the first grinding step to the inlet of the second mill, irrespective of whether it works continuously (open circuit) or in a closed circuit.

Portland cement is ground in the one-step or two-step method with the aid of one or two mills. A multi-component cement can also be produced with the aid of one or two mills. In this, the components are ground either commonly or separately, wherein a separate mixing step must be provided in the latter case. A significant energy consumption is required for the described grinding installations.

From M. Holland, M. von Seebach, W. Ranze: Drehzahlvariable Antriebe für Gutbett-Walzenmiihlen in “Zement-Kalk-Gips 7/1997”, pages 374-382, it is known to operate different mills and one classifier for each of them in a circuit, which are used in arrangements according to purpose (pre-grinding, combined grinding, hybrid grinding and completion grinding). From EP 0 374 491, the entire contents of which is incorporated herein by reference, a classifier is known which is particularly suited for grinding installations that are equipped with a material bed roller mill. The scabs delivered from such a roller mill are dissolved in a simple manner in this classifier which works as a desagglomerator at the same time.

From DE 43 20 025 A2, the entire contents of which is incorporated herein by reference, a grinding installation has become known which features a preliminary mill, i.e. a material bed roller mill (MBRM) in particular, a first classifier for classifying the material comminuted in the preliminary mill into a coarser and a finer fraction, a second classifier for classifying at least the finer fraction of the first classifier into coarse material and fine material, and a pulverizer, a ball mill in particular, for grinding the coarse material of the second classifier. The pulverizer and the second classifier are connected via a conveyor device that mechanically transports the material up to the second classifier.

The present invention is based on the objective to provide a method for the production of Portland slag cement and blast furnace cements that can be performed in a manner which saves energy and increases the use value of the cement.

### BRIEF SUMMARY OF THE INVENTION

In the method of the present invention, Portland cement clinker is charged into a first mill for preliminary grinding, the cement mill. The delivery material of the cement mill is supplied directly and/or via an intermediate reservoir into the inlet of a dynamic classifier, preferably one with adjusted separation cut. The oversized material of the dynamic classifier is supplied to the inlet of a mill. Slag meal (HSM) or slag grit (HSG) is additionally supplied into the inlet of the dynamic classifier. The delivery material discharged from the dynamic classifier is supplied into the inlet of a second mill for fine grinding. The delivery material of the second mill is supplied into the inlet of the dynamic classifier. Sulphate carrier is supplied either to the inlet of first mill, to the inlet of the dynamic classifier or to the inlet of the second mill. The fine material of the dynamic classifier is supplied to a reservoir.

If a clinker meal having a fineness corresponding to that of the Portland cement is provided instead of Portland cement, this clinker meal will be given to the classifier together with a dried fine-sized sulphate carrier.

Slag mills or cement mills are taken into consideration as mills. A vertical roller mill or a circulatory working stirred media mill may also be used with advantage.

In the present invention, Portland cement of the class CEM I 52.5 R is ground, starting from the classes CEM I 42.5 R or CEM I 32.5 R. However, a special cement having a high degree of fineness can also be ground according to the present invention.

By the invention, there is a post-refining of normal Portland cement in the common completion grinding of the multi-component cements (Portland slag cement or blast furnace cement) by way of a circulatory working cement mill in a slag mill.

The peculiar feature in the method of the present invention is that the Portland cement is first fed into a dynamic classifier for post-refining, so that only the accruing classifier grits feed the mill's inlet. Sulphate carrier can be ground together with the clinker in the first mill. In the other case, sulphate carrier is supplied to the inlet of the dynamic classifier. Alternatively, sulphate carrier is given into the inlet of the second mill.

In the method of the present invention, an existing slag mill that is better burdened for fine diminution is used for post-refining, whose ball diameters are stepped down for instance from 40 mm to 17 mm. The method may be realised even better by charging a cement mill used as second step for the post-refining not at the inlet of the mill, but according to the present invention at the classifier inlet with for instance a pre-cement (clinker meal plus fine-sized sulphate carrier, dry) or with a Portland cement of class CEM I 42.5 R or CEM I R 32.5 R. The ball diameters that are possible here are between 25 mm and 12 mm or even smaller. A higher energy efficiency is the consequence of this.

### DETAILED DESCRIPTION OF THE FIGURE IN THE DRAWINGS

An example of the realisation of the present invention will be explained in more detail in the following by way of a drawing.

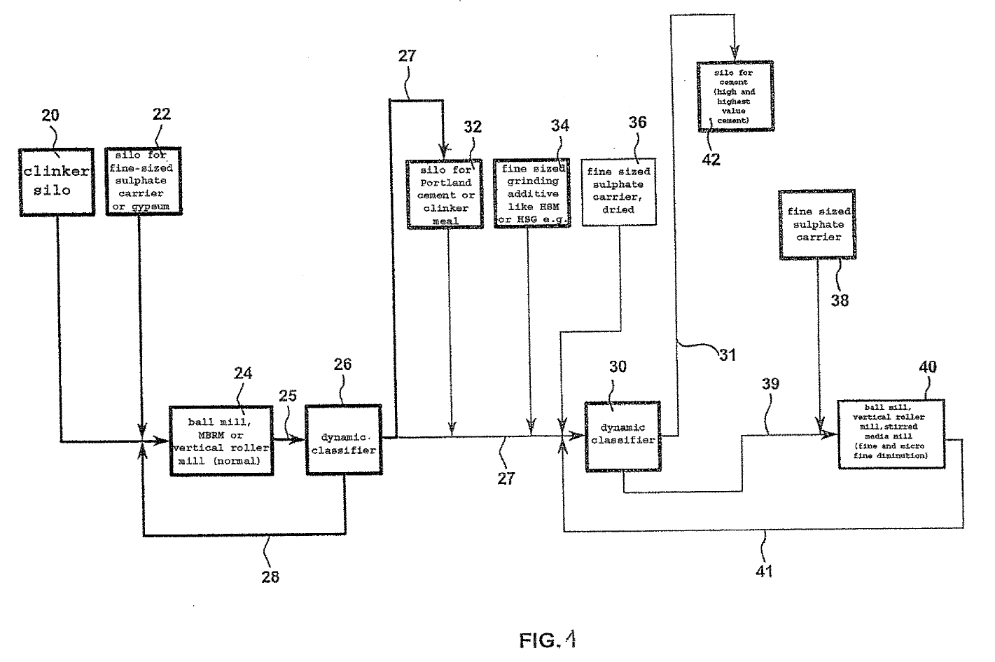

FIG. 1 shows a block diagram of a two-step grinding according to the method of the present invention.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated

A two-step grinding installation is shown in FIG. 1. From a clinker silo 20 and a sulphate carrier or gypsum silo 22, the materials to be ground are charged into a first mill 24, which may be a ball-, material bed roller- or a vertical roller mill. The delivery 25 of the mill 24 goes to the inlet of a dynamic classifier 26. The oversized material thereof arrives back at the inlet of the first mill 24 at 28. The fine grain delivery 27 of the dynamic classifier 26 goes to a dynamic classifier 30. Alternatively, the delivered fine material 27 of the dynamic classifier 26 arrives in a silo 32, which is likewise connected to the inlet of the dynamic classifier 30. From a further silo 34, fine sized grinding additive, slag meal or slag grit for instance, is supplied to the inlet of the dynamic classifier 30. Fine-sized dried sulphate carrier will be charged into the classifier 30 from a silo 36, together with the clinker meal and the grinding additive. If the addition of the fine-sized dried sulphate carrier does not occur before the dynamic classifier 30, the doping may alternatively also be performed from the silo 38 immediately before the mill 40.

The oversized material 39 from the dynamic classifier 30 arrives at the inlet of the mill 40, which may be for instance a ball mill, a vertical roller mill or a stirred media mill. The ball mill burdening is dimensioned for a fine- and micro diminution in this case. The delivery material of the mill 40 arrives in the inlet of the dynamic classifier 30 at 41. The fine material of the dynamic classifier 30 is fed into a cement silo 42 via a conveyor path 31. This fine material is Portland slag cement or blast furnace cement having a high fineness degree, wherein the same can be adjusted via the dynamic classifier 30 and the mill 40. The energy to be spent for the described process is significantly reduced compared to conventional grinding installations.

The implementation of the suggested technology will be demonstrated by way of the following realisation examples. The basis for this is the data obtained concerning a balanced reference condition (*) of a pulverizer for cement grinding that is operated in an open circuit (continuously). A dynamic classifier is arranged before this cement pulverizer in the following. Transportation paths of the grinding stock are realised for mill and classifier which permit the operation in the closed circuit between classifier and mill.

(*) The balanced pulverizer for cement grinding consists of a one-chamber tube ball mill with 3.6 in diameter and 10.5 m length.

(Case A) Utilisation of the cement pulverizer working in a closed circuit with a dynamic classifier for producing a Portland cement CEM I 52.5 R by classifying a clinker meal produced with a conventional grinding installation, including the addition of the necessary fine sized sulphate carrier, so that according to the present invention, only the accruing classifier grits are post-refined in the cement mill for so long until the post-refined material is discharged as completed cement in the fine material of the classifier.

Case B) Utilisation of the cement pulverizer working in a closed circuit with a dynamic classifier for producing a Portland slag cement CEM II/A-S 52.5 by simultaneously classifying clinker meal and slag meal which had been preliminarily ground in suitable grinding installations separately, so that according to the present invention, only the accruing classifier grits are post-refined in the cement mill for so long until the post-refined material is discharged as completed cement in the fine material of the classifier.

Table 1 contains the essential parameters concerning the above mentioned realisation examples.

TABLE 1
Obtainable parameters of a second grinding step classifier + pulverizer in a closed circuit

| | Reference condition (*) for | Case A | Case B |
|---|---|---|---|
| | the cases A and B: continuous | Circulatory grinding | Circulatory grinding |
| | grinding in a pulverizer | classifier + pulverizer: | classifier + pulverizer: |
| | with diameter 3.6 m length 10.5 m | diameter 3.6 m length 10.5 m | diameter 3.6 m length 10.5 m |
| Product | CEM I 52.5 R | CEM I 52.5 R | CEM II/A-S 52.5 R |
| Overall throughput t/h | 59 | 66 | 70 |
| Component A | Clinker meal | Clinker meal | Clinker meal |
| (Addition site: | | | |
| classifier inlet) | | | |
| d′RRSB μm | 14.4 | 15.5 | 14.4 |
| n RRSB | 1.00 | 0.99 | 1.00 |
| Blaine value cm²/g | 3600 | 3400 | 3600 |
| Component B | — | — | Slag meal |
| (Addition site: | | | |
| classifier input) | | | |
| Blaine value cm²/g | — | — | 4000 |
| Recipe: A %:B % | — | — | 80:20 |
| Classifier separation | — | 17 | 15 |
| cut size μm | | | |
| Unclassified proportion % | — | 27 | 30 |
| Classifier input amount t/h | — | 159 | 193 |
| Component A: | — | 47 | 43 |
| proportion directly into | | | |
| the completed product | | | |
| via classifier % | | | |
| Component B: | — | — | 42 |
| proportion directly into | | | |
| the completed product | | | |
| via classifier % | | | |
| Grit amount t/h | — | 93 | 123 |
| Blaine value cm²/g | 5250 | 5250 | 5700 |
| d′RRSB μm | 10.7 | 9.2 | 8.9 |
| n RRSB | 0.81 | 0.87 | 0.94 |
| Grinding ball filling | 24 | 27 | 28 |
| proportion of the | | | |
| pulverizer % | | | |
| Effective power of the | 1640 | 1850 | 1900 |
| pulverizer kW | | | |

In the following, some remarks will be given to the examples:
The required starting data stem from the presumed reference condition (*), see Table 1, column 2, and from the characteristic grindability curves of the component, for instance according to the bond test or the Zeisel test.
The grain structure of the completed material was given for the respective cement species in the form of characteristic values for the desired fineness.
The essential characteristic variables summarised in the table, namely mass flows (dry), parameters of the classifier separation curve and the characteristic variables for the fineness, were determined through model calculations by way of flow chart simulation.
A predicative calculation model serves for the calculation of the grinding installation within the flow chart simulation.
A suitable parameterised mapping serves for the calculation of the classifier flows: separated grain and unclassified proportion as a function of input fineness, load and the classifier's rotational speed.
The indication of the calculated Blaine values takes the correlation between the calculated surface and available values of the Blaine analysis into account.
The procedure is primarily oriented towards the utilisation of conventional tube ball mills, but can be transferred to other grinding machines (material bed roller mills (MBRM's), roller grinding mills etc.) however.

This completes the description of the preferred and alternate embodiments of the invention. Those skilled in the art may recognize other equivalents to the specific embodiment described herein which equivalents are intended to be encompassed by the claims attached hereto.

1. A method for the production of Portland slag cement and blast furnace cement by two-step grinding, comprising the following steps:
a) Portland cement clinker is charged into a first mill for preliminary grinding, the cement mill (24),
b) the delivery material of the cement mill (24) is supplied directly and/or via an intermediate reservoir into the inlet of a dynamic classifier (30),
c) slag meal or slag grit is additionally supplied into the inlet of the dynamic classifier (30),
d) oversized material discharged from the dynamic classifier (30) is supplied for pulverising into the inlet of a second mill (40),
e) the delivery material of the second mill (40) is fed into the inlet of the dynamic classifier (30), and
f) sulphate carrier is supplied either to the first mill (24), to the inlet of the dynamic classifier (30) or to the inlet of the second mill (40), and
g) the fine material of the dynamic classifier (30) is supplied to a reservoir (42).

2. A method according to claim 1, characterised in that a finely burdened cement mill or a slag mill is used as the second mill.

3. A method according to claim 2, characterised in that a ball mill, a vertical roller mill or a stirred media mill is used as the second mill.

4. A method according to claim 1, characterised in that grinding aids and/or substances for passivating the chromate reaction and/or substances which influence the product properties of cements and multi-component cements, like for instance the flow behaviour, the concrete compaction, setting accelerators and setting retarders are added from reservoirs provided for this purpose at suitable locations.

5. A method according to claim 1, characterised in that grinding additives are added from reservoirs provided for this purpose at the mill inlet of the second mill, which correspond in their granularities to the diminution behaviour of a mill that is adjusted to fine grinding.
